(19) United States
(12) Patent Application Publication
(10) Pub. No.: US 2010/0247904 A1
(43) Pub. Date: Sep. 30, 2010

(54) FLEXIBLE POLYUREA

(76) Inventors: Jim M. Larson, New Hope, MN (US); Fredrick S. Mulvany, Minnetonka, MN (US); Stephen E. Amos, Minneapolis, MN (US)

Correspondence Address: 3M INNOVATIVE PROPERTIES COMPANY, PO BOX 33427, ST. PAUL, MN, 55133-3427, US

(21) Appl. No.: 12/741,412

(22) PCT Filed: Oct. 31, 2008
(86) PCT No.: PCT/US08/82073

§ 371 Date: May 5, 2010

Related U.S. Application Data
(60) Provisional application No. 60/986,696, filed on Nov. 9, 2007.

(51) Int. Cl. C08G 18/30; B32B 27/28

(52) U.S. Cl. 428/339; 528/44; 521/163

(57) ABSTRACT

A flexible polyurea and method for making, as well as a kit for making the polyurea. The method and kit include making flexible polyurea by reacting at least a first component comprising at least one of an aliphatic isocyanate or an aromatic isocyanate and a second component comprising a secondary amine together, wherein the ratio of the first component to the second component was in the range from, by volume, 2:1 to 1:2. The flexible polyurea is useful, for example, as a substrate covering (e.g., the interiors of construction, farm, and other vehicles, both military and civilian (including cars, trucks, aircraft, and vessels (e.g., boats, ships, and submarines)).

### BACKGROUND

The use of two-part polyurea coatings to provide wear and tear resistance to more fragile substrates (e.g., as foam insulation) is desired, for example, in high wear applications (e.g., the interiors of military vehicles). In military vehicles substrates are generally formed to fit vehicle surfaces and, as such, may have combinations of vertical, inverted and horizontal surfaces. A general, conventional grade of polyurea can be used to coat horizontal surfaces without much regard to cure or gel time. Generally, conventional grades of polyurea, however, do not work well for 3-dimensional substrates where there is pooling, dripping or sagging on vertical or inverted surfaces. A need exists to have a flexible polyurea that can be easily spray coated on vertical or inverted surfaces without pooling, dripping or sagging.

Conventional two-part polyurea coatings are flexible and tear resistant but are also typically, undesirably slow to cure. Also, as a result of formulation changes that provide tear resistance and flexibility, conventional two-part polyurea coatings known in the art diverge from the common 1:1 volume ratios. For example, the ratio of the first and second components may vary in a range from 1:3 to 3:1 (or more).

Maintaining a good spray process is difficult when the mix ratio of one component is significantly different from the other component, especially if the material cures rapidly. The more divergent the volume ratio, the less robust the process is when slight changes in ratio occur. These changes can be due, for example, to variable pot pressures, fouling of lines and spray nozzles, build-up on filter packs, inhomogeneous viscosity, inhomogeneous dispersion of solids and poor temperature control.

### SUMMARY

In one aspect, the present disclosure provides a flexible polyurea comprising a reaction product of at least a first component comprising at least one of an aliphatic isocyanate or an aromatic isocyanate and a second component comprising a secondary amine together, wherein the ratio of the first component to the second component was in the range from, by volume, 2:1 to 1:2 (in some embodiments, in the range from 1.5:1 to 1:1.5, or even about 1:1). In some embodiments, the first and second components had, at 25° C., a first and second viscosity (determined as described in the Examples section, below) each greater than 144 Ku (typically up to 172 Ku (about 10,000 cps as (determined as described in the Examples section, below, a #6 spindle))). The term “flexible” as used herein means the polyurea has a Flexural Modulus (as described in the Examples section, below) up to 50 MPa. In some embodiments, the flexible polyurea has an (Izod) Impact Strength (determined as described in the Examples section, below) of at least 100 J/m (in some embodiments, at least 125 J/m, or even at least 150 J/m).

In another aspect, the present disclosure provides a method of making flexible polyurea, the method comprising reacting at least a first component comprising at least one of an aliphatic isocyanate or an aromatic isocyanate and a second component comprising a secondary amine, the first and second components having, at 25° C., a first and second viscosity (determined as described in the Examples section, below) each greater than 144 Ku (typically up to 172 Ku (about 10,000 cps as (determined as described in the Examples section, below, a #6 spindle))).

In another aspect, the present disclosure provides a kit for making polyurea, the kit comprising a first component comprising at least one of an aliphatic isocyanate or an aromatic isocyanate and a second component comprising a secondary amine, the first and second components having, at 25° C., a first and second viscosity (determined as described in the Examples section, below) each greater than 144 Ku (typically up to 172 Ku (about 10,000 cps as (determined as described in the Examples section, below, a #6 spindle))).

Flexible polyurea disclosed herein is useful, for example, as a substrate covering (e.g., the interiors of construction, farm, and other vehicles, both military and civilian (including cars, trucks, aircraft, and vessels (e.g., boats, ships, and submarines))).

### DETAILED DESCRIPTION

In some embodiments, the first component further comprises a first reaction product of at least (a) at least one of an aliphatic isocyanate or an aromatic isocyanate and (b) a secondary amine. Exemplary aliphatic isocyanates include 1,6-hexamethylene diisocyanate, 1,4-cyclohexyl diisocyanate, 1,4-bis-isocyanatomethyl-cyclohexane, and m- or p-tetramethylxylene diisocyanate, as well as hydrogenated derivatives of the organic aromatic polyisocyanates listed below. Aliphatic isocyanates can be made by techniques known in the art, and are available, for example, under the trade designations “TOLONATE HDT-LV2” (a hexamethylene diisocyanate) from Rhodia, Inc., Cranbury, N.J. Examplary aromatic isocyanates include 2,4-toluenediisocyanate, 2,6-toluenediisocyanate, p,p′-diphenylmethanediisocyanate, p-phenylenediisocyanate, naphthalenediisocyanate, and polymethylene polyphenylisocyanates. Aromatic isocyanates can be made by techniques known in the art, and are available, for example, under the trade designation “MONDUR” from Bayer Material Science AG, Leverkusen, Germany.

In some embodiments, the first component is provided by mixing at least (a) at least one of the aliphatic isocyanate or the aromatic isocyanate and (b) a sufficient amount of secondary amine (e.g., by weight, about 2 parts aliphatic isocyanate to 3 parts secondary amine) to provide the first component with the first viscosity. Typically, the secondary amine is added to the isocyanate slowly enough, and under agitation (e.g., via a vortex mixer (e.g., such as that available under the trade designation “DISPERMAT LC-USA from BYK-Gardner USA, Columbia, Md.) or via use of a stirring rod, etc.), such that the temperature of the mixture does not rise above about 49° C. (120° F.). Maintaining the mixture below this temperature facilitates providing a clear, water white consistency, as opposed to discoloration due to gel formation.

For first components comprising the first reaction product, in some embodiments, the weight ratio of the aliphatic isocyanate present in the first component to the first reaction product is in a range from about 2 to about 3.

Second components comprising a secondary amine, optionally further comprise at least one of a tertiary amine, an epoxy, or other chain extenders (e.g., polyols and polyethers) In some embodiments, the second component further comprises a second reaction product of at least a secondary amine, a tertiary amine, an epoxy, or other chain extenders. Secondary amines can be made by techniques known in the art, and are available, for example, under the trade designation “JEFFAMINE SD-2001” from Huntsman, Salt Lake City, Utah. Tertiary amines can be made by techniques known in the art, and are available, for example, under the trade designations “ETHACURE 100” from Albemarle Corp. Baton Rouge, La., and Huntsman T-5000″ from Huntsman. Epoxies can be made by techniques known in the art, and are available, for example, under the trade designation “EPON 828” from Hexion Speciality Chemicals, Columbus, Ohio.

In some embodiments, the second component is provided by reacting (e.g., mixing and gentle agitation) about 0.1 to 10 percent by weight epoxy to amine.

Optional additives for the first and/or second components include conventional flame retardants, colorants, surface modifiers, fillers (e.g., glass bubbles) thixotropes, defoamers, and biocides.

Techniques for mixing at least the first and second components together to make flexible polyurea include those known in the art for mixing conventional “A” and “B” components for making polyureas (e.g., via a static mixer, a fusion gun, and a Cowles mixer).

Typically, the ratio of the first component to the second component is in the range from, by volume, 2:1 to 1:2 (in some embodiments, in the range from 1.5:1 to 1:1.5, or even about 1:1). Typically, the first and second components have, at 25° C., a first and second viscosity (determined as described in the Examples section, below) each greater than 144 Ku (typically up to 172 Ku (about 10,000 cps as (determined as described in the Examples section, below, a #6 spindle))).

Flexible polyurea disclosed herein is useful, for example, as a substrate (e.g., a foam material, a ceramic (i.e., a glass, crystalline ceramic, glass-ceramic, or combination thereof) material, a metal material, a polymeric material, wood and natural products (e.g., cellulosic (e.g., cotton) fibers) covering (e.g., a substrate having a major surface with a flexible polyurea described herein thereon). In some embodiments, the flexible polyurea has a thickness in a range from 0.5 mm to 5 mm.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Example

A first component (“Component A”) comprising isocyanate was prepared as follows. Component A was made from 60 parts by weight of an aliphatic isocyante (a hexamethylene diisocyanate obtained under the trade designation “TOLONATE HDT-LV2” from Rhodia, North America, Cranbury, N.J.) blended with 40 parts by weight of a secondary amine (obtained under the trade designation “JEFFAMINE SD-2001” from Huntsman, Salt Lake City, Utah). The secondary amine was slowly added to the aliphatic isocyanate under agitation via a vortex mixer (obtained under the trade designation “DISPERMAT LC-USA” from BYK-Gardner USA, Columbia, Md.), taking care that the amount of secondary amine being added did not result in the temperature of the reaction product exceeding about 49° C. (120° F.). Once all the amine has been added, the mixture is allowed to continue mixing for about one hour. During this process, a dry nitrogen blanket was used to prevent a reaction between the water and isocyanate.

The viscosity of the aliphatic isocyante (equivalent weight (EW)=182 with a 23.0% by weight NCO content; “TOLONATE HDT LV2”), as measured, at 25° C., using a viscometer (obtained under the trade designation “KREBS STORMER VISCOMETER” from Brookfield Engineering, Middleboro, Mass.) was less than 54 Ku's and 680 cps as measured with a viscometer with #2 spindle (obtained under the trade designation “RVT BROOKFIELD” from Brookfield Engineering) at 2.5 rpms.

The viscosity of Component A, as measured, at 25° C., using a viscometer (“KREBS STORMER VISCOMETER”) was less than 54 Ku's, and 9600 cps as measured with a viscometer (“RVT BROOKFIELD”) with #6 spindle at 2.5 rpms.

A second component (“Component B”) comprising a secondary amine was prepared as follows. A mixture comprising 23.8 grams of diethyltoluenediamine (EW=89.5; obtained under the trade designation “ETHACURE 100” from Albemarle Corp. Baton Rouge, La.), 23.8 grams of trifunctional amine (EW=1667; obtained under the trade designation “JEFFAMINE T-5000” from Huntsman), 45.1 grams of a secondary amine (EW=1025; “JEFFAMINE SD-2001”), 0.09 gram of a blue colorant (obtained under the trade designation “PHTHALO BLUE G/S 853-7215” from CreaNova, Somerset, N.J.), 0.9 gram of a yellow colorant obtained under the trade designation “YELLOW OXIDE HULS 853-1810” from CreaNova), 0.09 gram of a red colorant (obtained under the trade designation “RED OXIDE HULS 853-1010” from CreaNova), 0.14 gram of a white colorant (obtained under the trade designation “TITANIUM WHITE HULS 853” from CreaNova), 0.14 gram of a black colorant (obtained under the trade designation “LAMP BLACK 853-9920” from CreaNova) were mixed together in the vortex mixer (“DISPERMAT LC-USA”). Component B was made by mixing 6 grams of an epoxy (EW=189; obtained under the trade designation “EPON 828” from Hexion Speciality Chemicals, Columbus, Ohio) into the resulting mixture using the vortex mixer (“DISPERMAT LC-USA”) under low speed agitation, and mixing for 1 hour. The resulting mixture was allowed to age 24 hours at 49° C. (120° F.) to ensure that the epoxy had completed its reaction with the amines in the formulation. Viscosity measurements were made using a viscometer (“KREBS STORMER VISCOMETER”) at 25° C. (77° F.). The viscosity of the epoxy-modified system exhibited a viscosity greater than 144 Ku's, which was about double that of the unmodified system.

A ⅛ inch (3.2 mm) aluminum panel (obtained under the trade designation “6061 T 651 aluminum” from Ryerson Company, Minneapolis, Minn.) was coated with a form oil (obtained under the trade designation “TK-709 UR” from Sierra Corporation, Minnetonka, Minn.), and then sprayed at a 1:1 by volume ratio onto the aluminum panel using a plural-component spray equipment reactor (Model H-XP2 from Graco Inc. Corporation, Minneapolis, Minn.) using the following machine settings: side A temperature, 82° C. (180° F.), side B temperature, 74° C. (165° F.); hose temperature, 82° C. (180° F.), and pressure, 21.4 MPa (3100 psi). The panel was sprayed with 6 coats of Components A and B, yielding a final polyurea coating that was ¼ inch (6.35 mm) thick. The resulting polyurea was removed from the aluminum panel.

### Comparative Example A

Comparative Example A (polyurea) was prepared as follows. Component A was made by mixing, using the vortex mixer (“DISPERMAT LC-USA”), a hexamethylene diisocyanate (85.2% by weight “TOLONATE HDT-LV2”) and a modified polyurea (1.3% by weight, obtained from BYK Chemie, Wesel, Germany, under the trade designation “BY 410”). The viscosity of Component A, as measured, at 22° C. (72° F.), using a viscometer (“KREBS STORMER VISCOMETER”) was less than 54 Ku's, and 680 cps as measured with a viscometer (“RVT BROOKFIELD”) with #2 spindle at 2.5 rpms.

Component B was made by mixing, using the vortex mixer (“DISPERMAT LC-USA”), a diethyltoluenediamine (32.4% by weight; “ETHACUR 100”), polyoxypropylenediamine (39.6% by weight, obtained from Huntsman Corporation under the trade designation “JEFFAMINE D-2000”), an aromatic secondary diamine (6.5% by weight, obtained from UOP, A Honeywell Company, Tonawanda, N.Y., under the trade designation “UNILINK 4200”), a trifunctional amine (2.4% by weight; “JEFFAMINE T-5000”), and a modified polyurea (0.8% by weight, obtained from BYK Chemie, Wesel under the trade designation “BYK 410”). The viscosity of Component B, as measured, at 22° C. (72° F.), using a viscometer (“KREBS STORMER VISCOMETER”) was less than 65 Ku's, and 370 cps as measured with a viscometer (“RVT BROOKFIELD”) with #3 spindle at 2.5 rpms.

Components A and B was sprayed at a 1:1 volumetric ratio as described in the Example, except the following machine settings were used: side A temperature, 79° C. (175° F.), side B temperature, 49° C. (120° F.); hose temperature, 79° C. (175° F.), and pressure, 17.9 MPa (2600 psi).

### Comparative Example B

Comparative Example B (polyurea) was prepared and sprayed at a 1:1 volumetric ratio as described for Comparative Example A, except the sprayed material included glass bubbles (available from 3M Company, St. Paul, Minn., under the trade designation “3M GLASS MICROSPHERES K37”). Component A included 13.5% by weight of the glass bubbles; Component B, 18.2% by weight. The viscosity of Component A, as measured, at 22° C. (72° F.), using a viscometer (“RVT BROOKFIELD”) with #6 spindle at 2.5 rpms, was 68,800 cps (equivalent to about 274 Ku). The viscosity of Component B, as measured, at 22° C. (72° F.), using a viscometer (“RVT BROOKFIELD”) with #6 spindle at 2.5 rpms, was 24,000 cps (equivalent to about 216 Ku).

### Density Test

The densities of the Example and Comparative Examples A and B were measured using a gas pycnometer (obtained under the trade designation “ACCU PYC 1330 GAS PYCNOMETER” from Micromeritics, Norcross, Ga.). The samples were cut to fit into the 109 cm³ cup, and the instructions in the Micromeritics operator's manual V3.03 (the disclosure of which is incorporated herein by reference) followed. The densities of the Example and Comparative Examples A and B were 0.9245 g/cm³, 0.9098 g/cm³, and 1.011 g/cm³, respectively.

### Shore A and D Hardness Tests

The Shore A and D Hardnesses of the Example and Comparative Examples A and B were measured according to ASTM D 2240-05 (2005) (Durometer (Shore) Hardness Test Method), the disclosure of which is incorporated herein by reference, using Shore “A” and Shore “D” hardness measurement equipment obtained from Instron Corporation, Norwood, Mass. under the trade designation “Shore Instrument and Manufacturing Co. Model Shore “A” and Shore “D”. The Shore A Hardness of the Example and Comparative Examples A and B were 88-90, 95-98, and 95-98, respectively. The Shore D Hardness of the Example and Comparative Examples A and B were 32-35, 72-75, and 67-70, respectively.

### Taber Abrasion Test

The Taber abrasion of the Example and Comparative Examples A and B were measured according to ASTM D 4060-01 (2001) (Taber Abraser Test Method) using a Tabor Abraser, the disclosure of which is incorporated herein by reference, (Model 5150 obtained from Taber Industries, North Tonawanda, N.Y.). The percent weight loss for the Example and Comparative Examples A and B were 0.033, 0.023, and 0.022, respectively.

### Tensile Strength and Strain to Failure Tests

The tensile strength and strain to failure of the Example and Comparative Examples A and B were evaluated at room temperature (i.e., about 23° C.) according to ASTM D 638 (2003), the disclosure of which is incorporated herein by reference, using equipment obtained under the trade designation “MTS ALLIANCE RF/100 HARDWARE” and data acquisition software obtained under the trade designation “TEST WORKS 5” (Version 4.08 B) from MTS Systems Corporation, Eden Prairie, Minn. The samples were fabricated to the Type 1 specimen geometry per the following dogbone shaped dimensions (4.4 mm thick nominal by 50 mm gage length wide by 15 mm gage width). The tensile strength and strain to failure data for the Example and Comparative Examples A and B are and the test Head Speed are reported in Tables 1-3, below.

TABLE 1
(Example)

| Cross- | | | | | |
|---|---|---|---|---|---|
| Head | Yield | Elongation | | | |
| Speed, | Stress, | % at | | Yield | Energy to |
| in/min | MPa | Break | Modulus, MPa | Stress, MPa | Break, J |
| 1 | 4.19 | 129 | 14 | 1.67 | 13.02 |
| 1 | 3.59 | 114 | 14 | 1.37 | 9.70 |
| 10 | 4.99 | 141 | 15 | 2.40 | 16.9 |
| 10 | 5.12 | 133 | 16 | 2.10 | 16.4 |
| 40 | 5.63 | 139 | 16 | 2.45 | 18.8 |
| 40 | 5.74 | 139 | 16 | 2.49 | 19.1 |
| Average | 4.88 | 133 | 15 | 2.08 | 15.7 |

TABLE 2
(Comparative Example A)

| Cross- | | | | | |
|---|---|---|---|---|---|
| Head | Yield | | | | |
| Speed, | Stress | | Modulus, | Yield | Energy to |
| in/min | MPa | Elongation % | MPa | Stress, MPa | Break, J |
| 1 | 18.35 | 10.52 | 296 | 13.49 | 5.79 |
| 1 | 18.55 | 9.61 | 306 | 15.58 | 3.14 |
| 1 | 17.7 | 9.91 | 270 | 15.03 | 3.08 |
| Average | 18.20 | 10 | 291 | 14.70 | 4.00 |

TABLE 3
(Comparative Example B)

| Cross- | Yield | | | | |
|---|---|---|---|---|---|
| Head | Stress, | | Modulus, | Yield | Energy to |
| in/min | MPa | Elongation % | MPa | Stress, MPa | Break, J |
| 0.5 | 20.7 | 15.77 | 121 | 18.52 | 7.34 |
| 1 | 24.43 | 26.96 | 130 | 20.63 | 18.3 |
| 1 | 23.72 | 22.89 | 207 | 8.36 | 15.42 |
| 10 | 23.56 | 18.32 | 204 | 11.01 | 11.53 |
| 40 | 21.75 | 17.31 | 162 | 15.66 | 10.57 |
| 40 | 21.75 | 17.31 | 162 | 15.66 | 10.57 |
| Average | 22.65 | 20 | 164 | 14.97 | 12.3 |

### Flexural Modulus Test

The flexural modulus of the Example and Comparative Examples A and B were evaluated in accordance with ASTM D790 (2007), the disclosure of which is incorporated herein by reference, using the test equipment software (“MTS ALLIANCE RF/100 HARDWARE” and “TEST WORKS 5 DATA ACQUISITION SOFTWARE” (Version 4.08 B)) from MTS Systems Corporation described above. The dimensions of the samples to be tested were 120 mm long by 12.7 mm wide by 198 mm (7.8 inch) thick. The span between the two outer supports was 100 mm. A force was applied at the center of the mounted sample. The results are reported in Table 4, below.

TABLE 4

| | | Flexular | % | |
|---|---|---|---|---|
| | Ultimate | Modulus, | Deflection | Break, |
| | Stress, MPa | (MPa) | at Yield | (Yes/No) |
| Example | 2.3 | 34 | 5.5 | N |
| Comparative | 20.2 | 464 | 4.2 | N |
| Example A | | | | |
| Comparative | 22.7 | 803 | 4.6 | Y |
| Example B | | | | |

### Izod Impact Test

The Izod impact test was used to evaluate the toughness of the Example and Comparative Examples A and B. The testing was conducted in accordance with D 256 (2006), the disclosure of which is incorporated herein by reference, using equipment obtained under the trade designation “CEAST RESIL IMPACTOR” from CEAST of Pianezza, Torino, Italy, configured with a 7.5 Joule hammer. The hammer arc velocity was 3.4 meters (11 feet) per second. The test results were recorded on a data acquisition system obtained under the trade designation “CEAST DAS 8000 DATA ACQUISITION SYSTEM” from CEAST of Pianezza. The energy was measured in joules and was defined as a function of material thickness. The results are reported below in Table 5 in terms of joules per meter material thickness (J/m).

TABLE 5

| | | Thickness, | |
|---|---|---|---|
| | Energy, J | mm | J/m |
| Example | 1.1 | 7.1 | 158 |
| Comparative | 0.4 | 6.1 | 68 |
| Example A | | | |
| Comparative | 0.16 | 6.2 | 25 |
| Example B | | | |

### Flammability Testing

The flammability of the Example and Comparative Examples A and B were evaluated using the UL 94HB (2006) Test, the disclosure of which is incorporated herein by reference. The geometry of the samples was in accordance with ASTM D 635 (2006) Test Specimen Geometry, the disclosure of which is incorporated herein by reference. To pass the UL HB94 Test, the burn rate cannot exceed 40 mm/minute. The results of the UL 94HB Test are reported in Table 6, below.

TABLE 6

| | Burn 1 | Burn 2 | Burn 3 | |
|---|---|---|---|---|
| Example | 207 | 190 | 187 | Seconds |
| Burn Rate | 21.7 | 23.7 | 24.1 | mm/min |
| Comparative | 119 | 142 | 120 | Seconds |
| Example A | | | | |
| Burn Rate | 37.8 | 31.7 | 37.5 | mm/min |
| Comparative | 215 | 209 | 175 | Seconds |
| Example A | | | | |
| Burn Rate | 20.9 | 21.5 | 25.7 | mm/min |

Various modifications and alterations of this invention will become apparent to those skilled in the art without departing from the scope and spirit of this invention, and it should be understood that this invention is not to be unduly limited to the illustrative embodiments set forth herein.

1. A flexible polyurea comprising a reaction product of at least a first component comprising at least one of an aliphatic isocyanate or an aromatic isocyanate and a second component comprising a secondary amine together, wherein the ratio of the first component to the second component was in the range from, by volume, 2:1 to 1:2.

2. The flexible polyurea according to claim 1, wherein the first component comprises at least one of an aliphatic isocyanate or an aromatic isocyanate.

3. (canceled)

4. The flexible polyurea according to claim 1, wherein the first and second components had, at 25° C., a first and second viscosity each greater than 144 Ku.

5. The flexible polyurea according to claim 1 having an Impact Strength of at least 100 J/m.

6. A substrate having a major surface with the flexible polyurea according to claim 1 thereon.

7. The substrate with the flexible polyurea thereon according to claim 6, wherein the substrate is a foam material.

8. The substrate with the flexible polyurea thereon according to claim 6, wherein the flexible polyurea has a thickness in a range from 0.5 mm to 5 mm.

9. A method of making flexible polyurea, the method comprising reacting a first component comprising at least one of an aliphatic isocyanate or an aromatic isocyanate and a second component comprising a secondary amine, the first and second components having, at 25° C., a first and second viscosity each greater than 144 Ku.

10. (canceled)

11. (canceled)

12. The method according to claim 9, wherein the ratio of the first component to the second component is in the range from, by volume, 2:1 to 1:2.

13. The method according to claim 9, wherein the first component further comprises a first reaction product of at least (a) at least one of an aliphatic isocyanate or an aromatic isocyanate and (b) a secondary amine.

14. The method according to claim 13, wherein the weight ratio of the aliphatic isocyanate present in the first component to the first reaction product is in a range from 2:3 to 1:4.

15. The method according to claim 9, wherein the second component further comprises a second reaction product of at least a secondary amine, a tertiary amine, and an epoxy.

16. The method according to claim 9, wherein the flexible polyurea is prepared by mixing the first and second components together via a static mixer or a fusion gun.

17. (canceled)

18. A kit for making flexible polyurea, the kit comprising a first component comprising at least one of an aliphatic isocyanate or an aromatic isocyanate and a second component comprising a secondary amine, the first and second components having, at 25° C., a first and second viscosity each greater than 144 Ku.

19. (canceled)

20. (canceled)

21. The kit according to claim 18, wherein the first component further comprises a first reaction product of at least (a) at least one of an aliphatic isocyanate or an aromatic isocyanate and (b) a secondary amine.

22. The kit according to claim 21, wherein the weight ratio of the aliphatic isocyanate present in the first component to the first reaction product is in a range from 2:3 to 1:4.

23. The kit according to claim 18, wherein the second component further comprises a second reaction product of at least a secondary amine, a tertiary amine, and an epoxy.

24. A method of making the kit according to claim 18, wherein the first component is provided by mixing at least (a) the at least one of the aliphatic isocyanate or the aromatic isocyanate and (b) a sufficient amount of secondary amine to provide the first component with the first viscosity.

25. A method of making the kit according to claim 18, wherein the second component is provided by mixing at least the secondary amine and a sufficient amount of epoxy to provide the second component with the second viscosity.
